(19) United States
(12) Patent Application Publication
(10) Pub. No.: US 2018/0168138 A1
(43) Pub. Date: Jun. 21, 2018

(54) MOSQUITO TRAP DEVICE

(71) Applicant: NATIONAL KAOHSIUNG UNIVERSITY OF APPLIED SCIENCES, Kaohsiung City (TW)

(72) Inventors: Hsiao-Yi LEE, Kaohsiung City (TW); Yu-Nan LIU, Kaohsiung City (TW); Yu-Jen LIU, Kaohsiung City (TW)

(21) Appl. No.: 15/828,817

(22) Filed: Dec. 1, 2017

(30) Foreign Application Priority Data
Dec. 16, 2016 (TW) 105141845

(51) Int. Cl. A01M 1/08

(52) U.S. Cl. CPC A01M 1/08

(57) ABSTRACT

A mosquito trap device includes a housing having an air inlet and an air outlet. A wind channel is formed between the air inlet and the air outlet. An ultraviolet light module is mounted in the housing and is located adjacent to the air inlet. A wind module is mounted in the wind channel of the housing. A mosquito detaining device includes a tube and a net. The tube is mounted in the wind channel and is coupled to the wind module. The net is mounted to and covers an end of the tube adjacent to the air inlet. A controller is electrically connected to the ultraviolet light module and the wind module. The controller is configured to output a pulse width modulation signal to the ultraviolet light module. The pulse width modulation signal has a frequency of 25-512 Hz.

### CROSS REFERENCE TO RELATED APPLICATIONS

The application claims the benefit of Taiwan application serial No. 105141845, filed on Dec. 16, 2016, and the entire contents of which are incorporated herein by reference.

### BACKGROUND OF THE INVENTION

### 1. Technical Field

The present invention relates to a mosquito trap device and, more particularly, to a mosquito trap device that operates with a pulse width modulation signal.

### 2. Description of the Related Art

Dengue fever caused by mosquitoes has raged many countries in the tropical zone and the subtropical zone. As an example, mosquitoes are active in the hot, rainy summer of Taiwan located in the subtropical zone. To avoid Dengue fever caused by mosquito bites, aside from preventing breeding of mosquitoes by cleaning water containers near the houses, chemicals or other mosquito repelling products are often used to achieve an effective mosquito repelling effect.

Furthermore, since mosquitoes are attracted by light and are sensitive to certain wavelengths, researchers pointed out that mosquito traps using a fluorescent lamp could be used to effectively capture mosquitoes. However, the fluorescent lamp has a low light emitting efficiency and consumes considerable electricity.

Thus, it is necessary to overcome the above disadvantages of the prior art to fulfill practical needs, increasing the utility.

### SUMMARY OF THE INVENTION

An objective of the present invention is to provide a mosquito trap device with a reduced power consumption rate while increasing the mosquito trapping effect.

A mosquito trap device according to the present invention includes a housing having an air inlet and an air outlet. A wind channel is formed between the air inlet and the air outlet. An ultraviolet light module is mounted in the housing and is located adjacent to the air inlet. A wind module is mounted in the wind channel of the housing. A mosquito detaining device includes a tube and a net. The tube is mounted in the wind channel and is coupled to the wind module. The net is mounted to and covers an end of the tube adjacent to the air inlet. A controller is electrically connected to the ultraviolet light module and the wind module. The controller is configured to output a pulse width modulation signal to the ultraviolet light module. The pulse width modulation signal has a frequency of 25-512 Hz.

In an example, the frequency of the pulse width modulation signal is 64 Hz.

In an example, the wind module is adjacent to the ultraviolet light module.

In an example, the net is mounted to the air outlet of the housing.

In an example, the mosquito trap device further includes a power management module electrically connected to the controller.

In an example, the power management module 6 has a solar battery.

In an example, the ultraviolet light module includes an optical element.

In an example, the optical element is a lens.

The mosquito trap device according to the present invention using the pulse width modulation pattern to activate the ultraviolet light module can effectively reduce the power consumption rate of the ultraviolet light module and can increase the mosquito trapping effect. Thus, the mosquito trap device according to the present invention using the pulse width modulation pattern provides an energy saving effect and an enhanced mosquito trapping effect.

The present invention will become clearer in light of the following detailed description of illustrative embodiments of this invention described in connection with the drawings.

### BRIEF DESCRIPTION OF THE DRAWINGS

FIG. 1 is a perspective view of a mosquito trap device according to the present invention.

FIG. 2 is a diagrammatic circuitry of a controller of the mosquito trap device according to the present invention, with the controller using a pulse width modulation pattern.

FIG. 3 is a bar chart illustrating the relationship between the enhanced trapping rate and frequency during operation of the mosquito trap device in different frequencies in which an ultraviolet light module using a linear pattern is used as a comparative example.

FIG. 4 is a bar chart illustrating the relationship between the number of trapped mosquitoes and time during operation of the mosquito trap device at different light diffusing angles of 135° and 160°.

FIG. 5 is a bar chart illustrating differences between the number of trapped mosquitoes using the mosquito trap device according to the present invention, using an ultraviolet light module incorporating a linear pattern, and using a conventional fluorescent lamp, respectively.

### DETAILED DESCRIPTION OF THE PREFERRED EMBODIMENTS

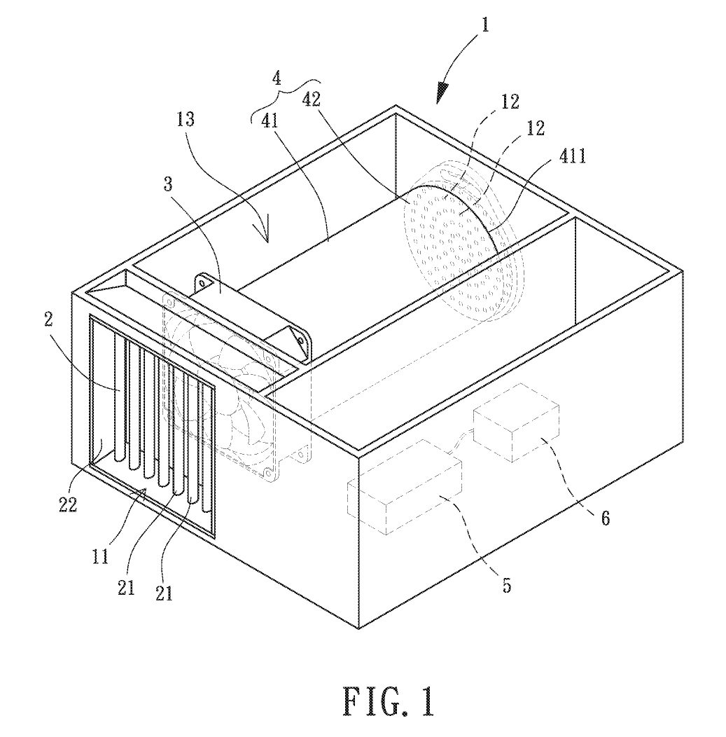

With reference to FIG. 1, a mosquito trap device according to the present invention includes a housing 1, an ultraviolet light module 2, a wind module 3, a mosquito detaining device 4, and a controller 5. The ultraviolet light module 2, the wind module 3, and the mosquito detaining device 4 are mounted in the housing 1. The controller 5 is electrically connected to the ultraviolet light module 2 and the wind module 3.

In this embodiment, the housing 1 includes an air inlet 11 and an air outlet 12. A wind channel 13 is formed between the air inlet 11 and the air outlet 12. As an example, the air inlet 11 and the air outlet 12 can be aligned with each other to permit the airflow to flow through the wind channel 13 more smoothly. Thus, when a mosquito is attracted to the air inlet 11 by the ultraviolet light module 2, the mosquito can be effectively sucked into the wind channel 13 by the wind module 3, increasing the mosquito trapping effect. The shape and material of the housing 1 can be varied according to practical needs.

The ultraviolet light module 2 can be mounted in the housing 1 at a position adjacent to the air inlet 11, such that the mosquito can be attracted more easily to a position near the air inlet 11, thereby increasing the mosquito trapping effect. The ultraviolet light module 2 includes at least one lighting element 21 (such as light-emitting diode lamps or light bars with chips emitting ultraviolet light). In this embodiment, the ultraviolet light module 2 includes a plurality of LED lamps. The ultraviolet light module 2 further includes an optical element 22, such as a lens. The optical element 22 can diffuse the light emitted by the at least one lighting element 21 to increase the light diffusing angle, thereby increasing the mosquito trapping effect.

The wind module 3 is mounted in the wind channel 13 of the housing 1. The wind module 3 can be a fan. In this embodiment, the wind module 3 is located adjacent to the ultraviolet light module 2. Thus, when a mosquito is attracted to a position near the ultraviolet light module 2, the mosquito can be effectively sucked by the wind module 3 into the wind channel 13, increasing the mosquito trapping effect.

The mosquito detaining device 4 includes a tube 41 and a net 42. The tube 41 is mounted in the wind channel 13 and is coupled to the wind module 3. The net 42 is mounted to and covers an end 411 of the tube 41 adjacent to the air inlet 12. In this embodiment, the net 42 is mounted to the air outlet 12 of the housing 1 to increase the space for detaining the mosquitoes and to reduce the frequency of cleaning the mosquitoes in the tube 41, thereby increasing use convenience.

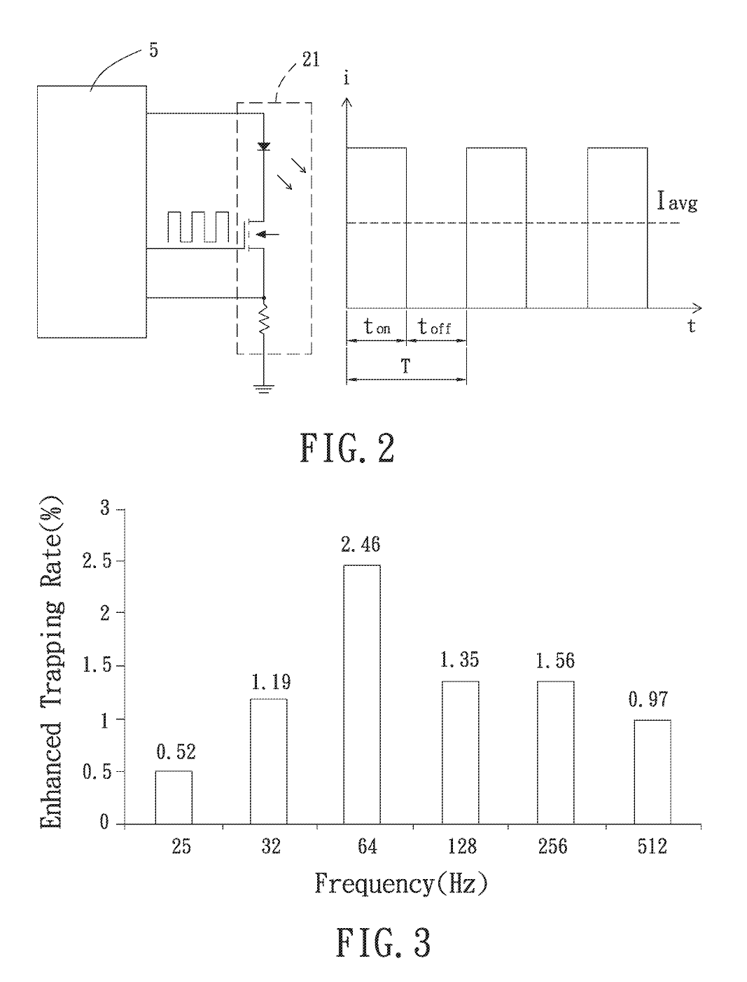

With reference to FIGS. 1 and 2, the controller 5 is electrically connected to the ultraviolet light module 2 and the wind module 3. The controller 5 is set to a pulse width modulation (PWM) pattern and is configured to output a pulse width modulation signal to the ultraviolet light module 2 for controlling the duty cycle T of the ultraviolet light module 2. Specifically, the duty cycle T of the ultraviolet light module 2 consists of a conductive period tₒₙ and a cut-off period t_{off} of a switch of the ultraviolet light module 2, and the average current value I_{AVG} for activating the ultraviolet light module 2 is in direct proportion to the duty cycle T. Thus, the controller 5 switches the duty cycle T from 0% to 100% to change the luminous intensity of the ultraviolet light module 2. Furthermore, in this embodiment, the pulse width modulation signal has a frequency of 25-512 Hz (see FIG. 3). Preferably, the frequency of the pulse width modulation signal is 64 Hz to increase the mosquito trapping effect.

FIG. 3 is a bar chart illustrating the relationship between the enhanced trapping rate and frequency during operation of the mosquito trap device in different frequencies in an experiment in which an ultraviolet light module using a linear pattern is used as a comparative example. In this experiment, the power consumption rate of the ultraviolet light module 2 of the mosquito trap device according to the present invention is 0.9 W, and the power consumption rate of the ultraviolet light module using the linear pattern (the comparative example) is 1.5 W. When the pulse with modulation frequency is lower than 25 Hz or higher than 512 Hz, the enhanced trapping rate of the mosquito trap device according to the present invention (relative to the trapping rate of the ultraviolet light module using the linear pattern) is relatively lower. Nevertheless, when the pulse with modulation frequency is 64 Hz, the enhanced trapping rate of the mosquito trap device according to the present invention is the best as compared to the trapping rate of the ultraviolet light module using the linear pattern. Thus, the mosquito trap device according to the present invention provides an energy saving effect and increases the mosquito trapping effect.

With reference to FIG. 1, the mosquito trap device according to the present invention can further include a power management module 6 (such as a battery) electrically connected to the controller 5 for supply electricity. Furthermore, the power management module 6 can have a solar battery for outdoor use, providing use convenience.

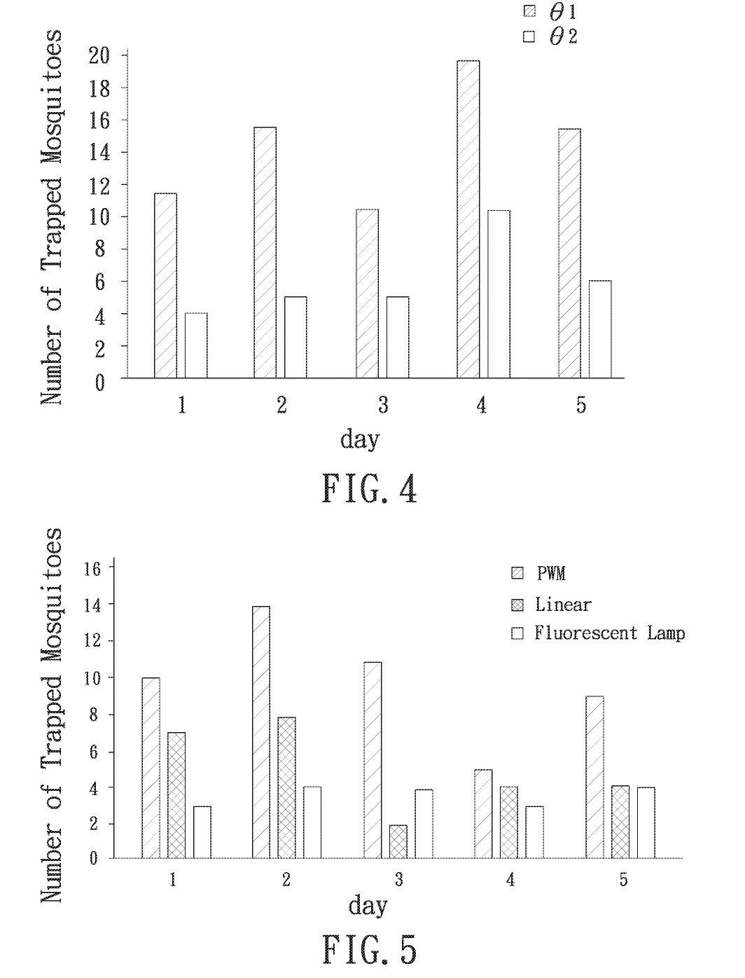

To prove the mosquito trapping effect of the mosquito trap device according to the present invention, experiments are conducted in various conditions of the mosquito trap device according to the present invention (with or without the optical element 22 and pulse width modulation signals of different frequencies). With reference to FIG. 4, the mosquito trap device with the optical element 22 has a first light diffusing angle θ1 of 160°, and the mosquito trap device without the optical element 22 has a second light diffusing angle θ2 of 135°. As can be seen from FIG. 4, the number of trapped mosquitoes is increased by increasing the light diffusing angle, increasing the mosquito trapping effect.

FIG. 5 is a bar chart illustrating differences between the number of trapped mosquitoes using the mosquito trap device according to the present invention, using an ultraviolet light module incorporating a linear pattern, and using a conventional fluorescent lamp, respectively. The power consumption rate of the fluorescent lamp is 10 W. The power consumption rate of the ultraviolet light module using the linear pattern is 1.5 W. The ultraviolet light module 2 of the present invention uses a pulse width modulation signal of 64 Hz and has a power consumption rate of 0.9 W. As can be seen from FIG. 5, the number of mosquitoes trapped by the mosquito trap device according to the present invention using the pulse width modulation pattern is significantly larger than those trapped by the ultraviolet light module using the linear pattern and by the conventional fluorescent lamp.

In view of the foregoing, the mosquito trap device according to the present invention using the pulse width modulation pattern to activate the ultraviolet light module 2 can effectively reduce the power consumption rate of the ultraviolet light module 2 and can increase the mosquito trapping effect. Thus, the mosquito trap device according to the present invention using the pulse width modulation pattern provides an energy saving effect and an enhanced mosquito trapping effect.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A mosquito trap device comprising:
a housing including an air inlet and an air outlet, wherein a wind channel is formed between the air inlet and the air outlet;
an ultraviolet light module mounted in the housing and located adjacent to the air inlet;
a wind module mounted in the wind channel of the housing;
a mosquito detaining device including a tube and a net, wherein the tube is mounted in the wind channel and is coupled to the wind module, wherein the net is mounted to and covers an end of the tube adjacent to the air inlet; and
a controller electrically connected to the ultraviolet light module and the wind module, wherein the controller is configured to output a pulse width modulation signal to the ultraviolet light module, and wherein the pulse width modulation signal has a frequency of 25-512 Hz.

2. The mosquito trap device as claimed in claim 1, wherein the frequency of the pulse width modulation signal is 64 Hz.

3. The mosquito trap device as claimed in claim 1, wherein the wind module is adjacent to the ultraviolet light module.

4. The mosquito trap device as claimed in claim 1, wherein the net is mounted to the air outlet of the housing.

5. The mosquito trap device as claimed in claim 1, further comprising a power management module electrically connected to the controller.

6. The mosquito trap device as claimed in claim 5, wherein the power management module has a solar battery.

7. The mosquito trap device as claimed in claim 1, wherein the ultraviolet light module includes an optical element.

8. The mosquito trap device as claimed in claim 7, wherein the optical element is a lens.
